(19) United States
(12) Patent Application Publication
(10) Pub. No.: US 2026/0076340 A1
(43) Pub. Date: Mar. 19, 2026

(54) POUCH FOR DISPENSING SQUEEZABLE ANIMAL TREAT AND METHODS

(71) Applicant: Spectrum Brands, Inc., Middleton, WI (US)

(72) Inventor: Blake Shadow, Middleton, WI (US)

(21) Appl. No.: 18/889,867

(22) Filed: Sep. 19, 2024

(51) Int. Cl. A01K 5/01; B65D 35/44

(52) U.S. Cl. CPC A01K 5/0121; B65D 35/44

(57) ABSTRACT

A pouch for dispensing a squeezable animal treat includes a flexible, squeezable wall with an interior volume and a spoon integral and non-removably secured to the body. The pouch has a non-circular opening with a first section of open volume and a second section of open volume. The first section has a greater area of open volume than the second section.

### TECHNICAL FIELD

This disclosure relates to a squeezable pouch for convenient dispensing and serving of an animal treat. In particular, this disclosure relates to a squeezable pouch having an integral spoon and methods of use.

### BACKGROUND

Many pet owners like to give their pets special treats that are highly appetizing for the animal. While some animals are easy to please, other animals are more finicky. In particular, cats can be especially finicky.

One type of pet treat in the prior art is a non-solid food, such as a puree. While purees are popular with many cats, a common complaint among the pet owners is that it is a messy product to give to their animal. The packaging does not provide for easy dispensing or feeding, and the pet owner will often get the food on their hands.

Improvements are desirable.

### SUMMARY

In general, a pouch for dispensing a squeezable animal treat is provided that addresses the problems in the prior art.

In general, a pouch for dispensing a squeezable animal treat is provided. The pouch comprises (a) a pouch body including a flexible, squeezable surrounding wall defining an interior volume; the body including an opening in communication with the interior volume; (b) a spoon integral with and non-removably secured to the body; and (c) the opening being non-circular with a first end adjacent to the spoon, and an opposite second end remote from the spoon; (i) the opening having a length from the first end to the second end; (ii) the opening having a first section of open volume from the first end to 50% of the length, and a second section of open volume from the first section to the second end; and (iii) the first section having a greater area of open volume than the second section.

In some arrangements, the opening has a width narrower at the second end than the first end.

In some embodiments, the first section has a dimension of greatest width greater than any other width in the opening.

In example implementations, the dimension of greatest width of the first section is 4-6 mm.

In some arrangements, the length of the opening is 6-9 mm.

In some embodiments, a ratio of the dimension of greatest width of the first section to the length of the opening is between: 0.6 and 0.8.

In example implementations, the opening is a polygon.

In some arrangements, the opening is one of: pie-wedge shaped; tear-drop shaped; irregularly-shaped; or heart-shaped.

In some embodiments, the spoon comprises a concave bowl surrounded by a frame.

In some arrangements, the open area of the opening is at least 5% and not greater than 15% of an area of the concave bowl of the spoon.

In example implementations, the open area of the opening is between 7-10% of an area of the concave bowl of the spoon.

In some embodiments: (a) the body has opposite side edges, a free end edge between the side edges, and a spoon-interface edge opposite of the free end edge and between the side edges; (b) the body further defines a bottom panel and an opposite top panel, each being surrounded by the side edges, free end edge, and spoon-interface edge; wherein the opening is through the top panel of the body.

In some arrangements, the first end of the opening is spaced between 1 and 15 mm from the spoon-interface edge.

In some embodiments, the first end of the opening is spaced between 3 and 10 mm from the spoon-interface edge.

In example implementations, a ratio of a circumference of the opening to a circumference of the concave bowl is between 0.2 and 0.4.

In some arrangements, the pouch further includes a removable tab covering the opening.

In some embodiments, the interior volume is sized to hold 1-6 ounces of material.

In example implementations, the pouch further comprises a non-solid foodstuff suitable for animal consumption in the interior volume; the foodstuff having a viscosity of at least 80,000 cps and not more than 180,000 cps at 23° C.

In some arrangements, the non-solid foodstuff comprises any one of a puree, mash, mush, paste, liquid, sauce, broth, chowder, stew, gravy, juice, or bisque.

In some embodiments, (a) the bottom panel of the body also is a bottom side of the pouch; and
(b) the spoon and body comprise a same continuous material.

In example implementations, (a) the body is elongated, having an aspect ratio of 2 - 6; (b) the opening is one of: pie-wedge shaped; tear-drop shaped; irregularly-shaped; or heart-shaped; (c) the open area of the opening is between 7-10% of an area of the concave bowl; (d) a ratio of a circumference of the opening to a circumference of the concave bowl is between 0.2 and 0.4; and
(e) the pouch includes a non-solid foodstuff suitable for animal consumption in the interior volume; the foodstuff having a viscosity of at least 80,000 cps and not more than 180,000 cps at 23° C.

In another aspect, a method of dispensing a squeezable animal treat is provided. The method comprising: (a) providing a pouch body containing a non-solid foodstuff suitable for animal consumption; the body including an opening in communication with the interior volume; and a spoon integral and non-removably secured to the body; (i) the opening being non-circular with a first half adjacent to the spoon, and an opposite second half remote from the spoon; (ii) the first half having a greater area of open volume than the second half; (b) putting the spoon into a dispensing configuration; and (c) squeezing the pouch body to dispense the foodstuff from within the pouch body through the opening and onto the spoon.

In some arrangements, the step of putting the spoon into a dispensing configuration includes bending an interface between the pouch body and the spoon so that the spoon is angled at a non-zero angle relative to the body.

In some embodiments, the method further includes removing a tab covering the opening.

In example implementations, the step of providing a pouch body includes providing the pouch body having the non-solid foodstuff having a viscosity of at least 80,000 cps and not more than 180,000 cps at 23° C.

In some arrangements, the step of providing a pouch body includes providing the pouch body to having the opening being one of: pie-wedge shaped; tear-drop shaped; irregularly-shaped; or heart-shaped; and the open area of the opening being between 5-15% of an area of the spoon.

In some embodiments, the method further includes, before squeezing the pouch body, removing a tab covering the opening.

In example implementations, the method further includes, after squeezing the pouch body, covering the opening with the tab.

A variety of examples of desirable features or methods are set forth in the description that follows.

### BRIEF DESCRIPTION OF THE DRAWINGS

FIG. 1 is a top plan view an embodiment of a squeezable pouch, constructed in accordance with principles of this disclosure;

FIG. 2 is a top plan view of packaging for the pouch of FIG. 1, before being assembled into the final pouch of FIG. 1;

FIG. 3 is an enlarged view of an opening in the pouch of FIG. 1;

FIG. 4 is a partial perspective view of the pouch of FIG. 1, during one step of use;

FIG. 5 is a perspective view of the pouch of FIG. 1, during one step of use;

FIG. 6 is a perspective view of the pouch of FIG. 1, during one step of use;

FIG. 7 is a perspective view of the pouch of FIG. 1, during one step of use;

FIG. 8 is an enlarged view of an alternative embodiment of an opening in the pouch of FIG. 1;

FIG. 9 is an enlarged view of an alternative embodiment of an opening in the pouch of FIG. 1;

FIG. 10 is an enlarged view of an alternative embodiment of an opening in the pouch of FIG. 1; and

FIG. 11 is an enlarged view of an alternative embodiment of an opening in the pouch of FIG. 1.

### DETAILED DESCRIPTION

Described herein is an easy squeeze and serve pouch that is a mess-free method of feeding liquid or soft or moist pet food or treats. The pouch described herein contains an integral spoon, and the food/treat can easily squeeze out of the pouch and onto the spoon, where the pet can lick the food/treat for easy consumption. The packaging can then be closed by a cover/tab and stored for future use.

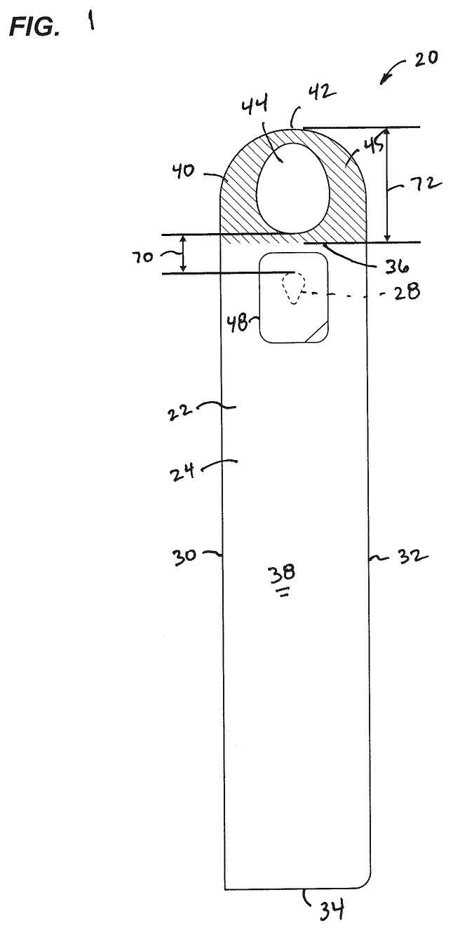

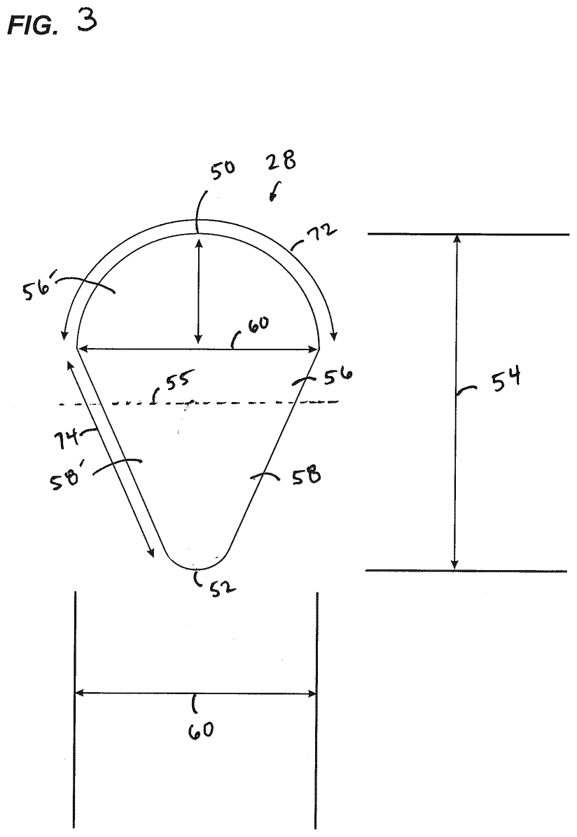

In reference now to FIGS. 1-3, the pouch is shown generally at 20. The pouch 20 includes a pouch body 22. The pouch body is made from a flexible, squeezable surrounding wall 24 defining an interior volume 26 (FIG. 4). The wall 24 can be made from a variety of materials including flexible materials such as a flexible plastic or a flexible polymeric material. The materials can also be a variety of laminated plastics, or aluminum material.

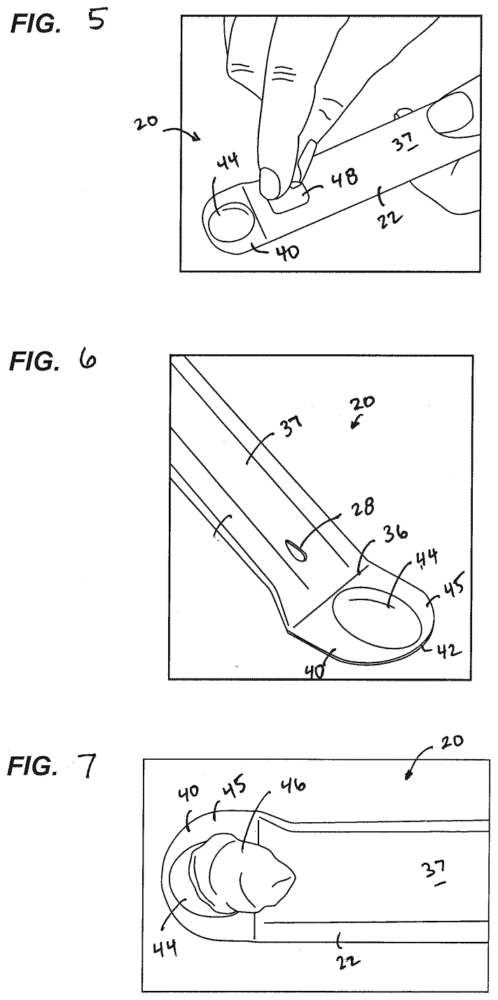

The body 22 includes an opening 28. The opening 28 defines a through hole in communication with the interior volume 26. In use, the treat or food 46 (FIG. 7) dispensed from the pouch 22 will be squeezed from the interior volume 26 through the opening 28.

The interior volume 26 of the pouch 20 is sized to hold no more than about 8 ounces of material, such as a non-solid food for animals. In one example, the volume is sized to hold about 1-6 ounces. In other embodiments, it is sized to hold about 1-4 ounces.

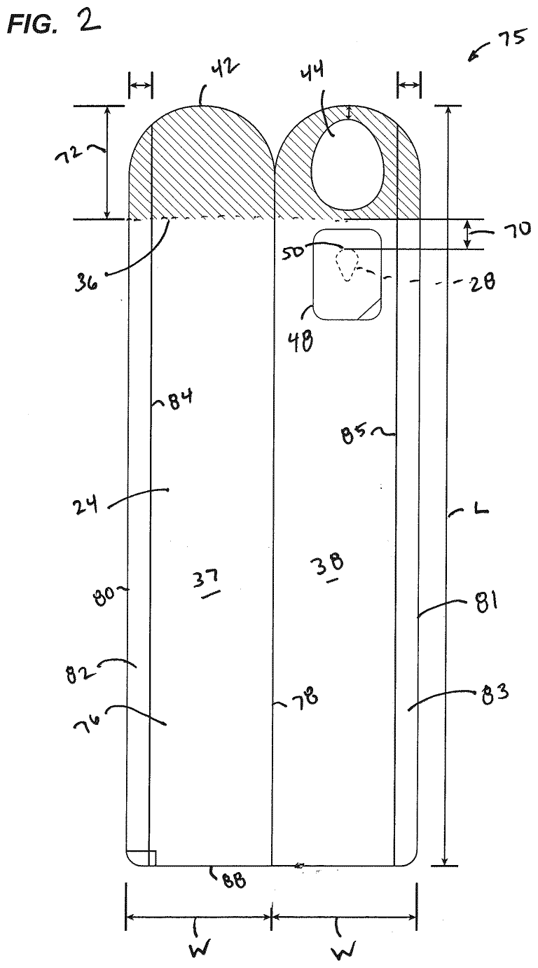

As can be seen in the example in FIG. 1, the pouch 20 has a pair of side edges 30, 32 joined by a free end edge 34. Opposite the free end edge 34 is a spoon-interface edge 36. As will be further explained below, a spoon 40 is part of the pouch 20, and extends from the spoon-interface edge 36 of the body 22 to a free end 42 of the pouch 20, opposite of the spoon-interface edge 36. In general, the free end edge 34 and spoon-interface edge 36 defines the width W (see FIG. 2), while the side edges 30, 32 define the length L (FIG. 2) of the pouch 20. The opening 28 is adjacent the spoon-interface edge 36.

The surrounding wall 24 of the body 22 includes a bottom panel 37 and an opposite top panel 38. Each of the panels 37, 38 is surrounded by the side edges 30, 32, free end edge 34, and spoon-interface edge 36. The opening 28 is through the top panel 38. The bottom panel 37 is also a bottom side 39 of the pouch 20.

The body 22 is sized such that it can be easily held within a typical human hand. In many examples, the body 22 is elongated and has an aspect ratio of length L to width W between 2 and 6, inclusive. That is, the length L can be anywhere from twice the width W to six times the width W. There are many other examples.

In general, the pouch 20 further includes a spoon 40. The spoon 40 is integral with and non-removably secured to the body 22 at the spoon-interface edge 36. The spoon 40 is adjacent to the opening 28 in the body 22. This arrangement is to allow for convenient and non-messy dispensing of the material in the interior volume through the opening 28 and onto the spoon 40. The spoon 40 has a concave bowl 44, surrounded by a frame 45. The frame 45 can include ribbing for texture.

The spoon 40 is preferably the same continuous piece of material as the body 22. In many instances, the spoon 40 further includes additional layers of material, such as compressed aluminum film, to allow the spoon 40 to have some additional stiffness (relative to the pouch body 22), and be deformable for holding the shape of the bowl 44. In addition, the pouch body 22 can be bent along the spoon-interface edge 36, such that the spoon 40 is angled at a non-zero angle (such as 90°-175°) relative to the body 22, to allow easy flowing of foodstuff 46 in the body 22 from the opening 28 into the bowl 44. The length of the spoon 40 from the free end 42 to the spoon-interface edge 36 is shown at dimension 72. The length of the spoon 40 at 72 relative to the overall length L of the pouch 20 is 10-20%, typically about 14-16%.

FIG. 2 shows the packaging 75 for the pouch 20, prior to being assembled into the final pouch 20. The packaging 75 shows one continuous piece of material 76, which is folded along fold line 78. The fold line 78 becomes the side edge 30 (FIG. 1) in the final pouch 20. Opposite edges 80, 81 of the packaging material 76 are sealed together along seal regions 82, 83, with seal lines shown at 84, 85, to form the side edge 32 of the pouch 20. The bottom edge 88 of the packaging material 76 is joined by a seal to form the free end edge 34. There is also a seal along the spoon-interface edge 36, to separate the pouch body 22 from the spoon 40.

The pouch 20 will include non-solid foodstuff 46 (FIG. 7) suitable for animal consumption in the interior volume 26. The foodstuff 46 may comprise a variety of materials including any one or combination of a puree, mash, mush, paste, liquid, sauce, broth, chowder, stew, gravy, juice, or bisque. The foodstuff 46 can be a variety of meats, vegetables, grains, or other foods including seafood, such as tuna or salmon; poultry such as chicken or turkey; or beef, and including organs such as liver or hearts. The foodstuff 46 has a viscosity that is of consistency that will flow well through the opening 28. In many examples, the viscosity is at least 80,000 cps and not more than 180,000 cps at 23° C.

The pouch 20 may further include a removable tab 48. The tab 48 covers the opening 28, and is removed to expose the opening 28. The tab 48 may include an adhesive, to allow for a removable securement of the tab 48 to the top panel 38 of the body 22, covering the opening 28. The adhesive on the tab 48 can also allow for re-attachment to the panel 38, to re-cover the opening 28.

In reference now to FIG. 3, the opening 28 is further described. The opening 28 has an outer perimeter shape that is designed to allow for a better, more controlled flow of the foodstuff 46 through the opening 28.

In general, the opening 28 is non-circular. The opening 28 has a first end 50 adjacent to the spoon 40, and an opposite second end 52 remote from the spoon 40. The opening 28 has a length 54 from the first end 50 to the second end 52. The opening 28 has a first section 56 of open volume from the first end 50 to 50% of the length 54 to broken line 55, and a second section 58 of open volume from the first section 56 (from broken line 55) to the second end 52. The first section 56 has a greater area of open volume than the second section 58. Stated another way, the opening has a first half 56′ adjacent to the spoon 40, and an opposite second half 58′ remote from the spoon 40. The first half 56′ has a greater area of open volume than the second half 58′.

Still in reference to FIG. 3, the opening 28 has a width narrower at the second end 52 than the first end 50. The first section 56 has a dimension 60 of greatest width greater than any other width in the opening 28. In example arrangements, the dimension 60 of greatest width of the first section 56 is at least 3 mm, not greater than 10 mm, and typically 4-6 mm.

The length 54 of the opening 28 between the first end 50 and second end 52 is at least 5 mm, not greater than 12 mm, and typically 6-9 mm. In many preferred arrangements, a ratio of the dimension of greatest width 60 of the first section 56 to the length 54 of the opening 28 is between: 0.6 and 0.8.

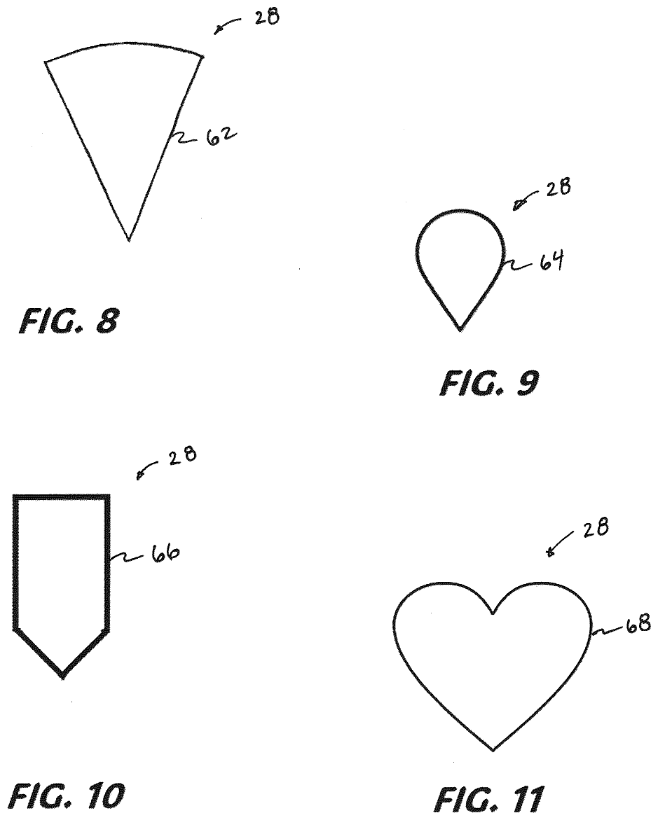

The opening 28, as mentioned above, is non-circular. It can have a variety of shapes. For example, the opening 28 can be a regular or irregular polygon shape. Other examples include the opening 28 being: pie-wedge or sector shaped 62 (FIG. 8); tear-drop shaped 64 (FIG. 9); irregularly-shaped, such as an irregular pentagon 66 (FIG. 10); or heart-shaped 68 (FIG. 11). Preferably, the opening 28 is symmetrical along its length, but need not be.

In many preferred arrangements, the open area of the opening 28 is at least 5% and not greater than 15% of an area of the concave bowl 44 of the spoon 40. Typically, the open area of the opening 28 is between 7-10% of an area of the concave bowl 44 of the spoon 40.

Preferably, the first end 50 of the opening 28 is spaced at 70 (FIG. 2) between 1 and 15 mm from the spoon-interface edge 36; and typically between 3 and 10 mm from the spoon-interface edge 36.

In example arrangements, a ratio of a circumference of the opening 28 to a circumference of the concave bowl 44 is between 0.2 and 0.4. A ratio of the length of the curve of the opening 28 shown at 72 (FIG. 3) to the length at 74 from the dimension 60 of greatest width of the opening 28 is between 1.4 and 1.6, typically about 1.5.

The above embodiments can be used in a method of dispensing a squeezable animal food/treat. The method includes providing a pouch body containing a non-solid foodstuff suitable for animal consumption. The body includes an opening in communication with the interior volume and a spoon integral and non-removably secured to the body. The opening is non-circular with a first half adjacent to the spoon, and an opposite second half remote from the spoon. The first half has a greater area of open volume than the second half. Examples of the pouch body include the pouch body 22 of FIG. 1.

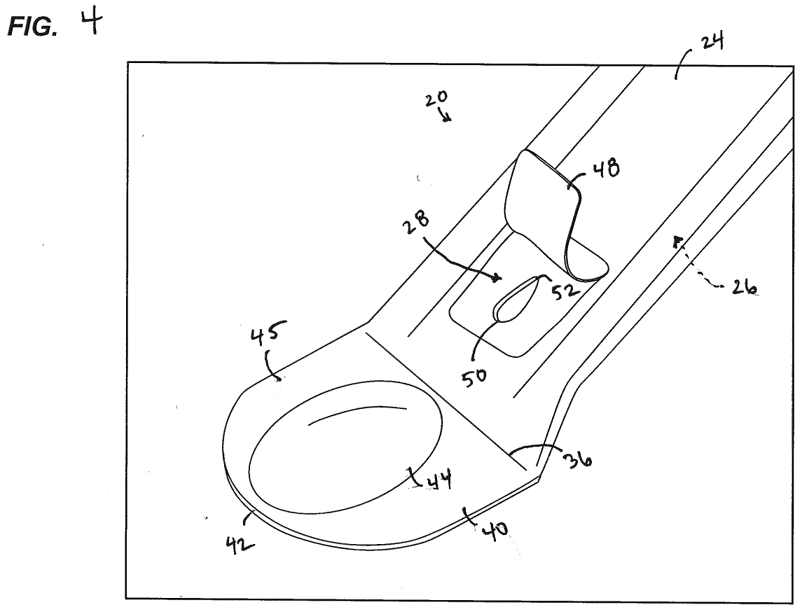

The method includes putting the spoon 40 into a dispensing configuration. Examples include putting the spoon 40 into the dispensing configuration as shown in, for example, FIGS. 4 and 6.

The method further includes a step of squeezing the pouch body 22 to dispense the foodstuff 46 within the pouch body 22 and onto the spoon bowl 44. See FIG. 7.

The step of putting the spoon 40 into a dispensing configuration includes, for example, bending an interface 36 between the pouch body 22 and the spoon 40 so that the spoon 40 is angled at a non-zero angle relative to the body 22.

The method can include a step of removing tab 48 covering the opening 28.

The method may further include, after squeezing the pouch body 22, covering the opening 28 with the tab 48.

The step of providing the pouch body 22 includes providing a non-solid foodstuff comprising any one or combination of puree, mash, mush, paste, liquid, sauce, broth, chowder, stew, gravy, juice, or bisque.

The non-solid foodstuff can be meats, vegetables, fruits, or grains including: seafood such as tuna or salmon; poultry such as chicken or turkey; or beef including organs such as liver or heart; or any combination.

The step of providing the pouch body 22 can include providing the pouch body 22 to have the non-solid foodstuff with a viscosity of at least 80,000 cps and not more than 180,000 cps at 23° C.

The step of providing the pouch body 22 can include providing the pouch body 22 to have the opening 28 be one of: pie-wedge shaped 62; tear-drop shaped 64; or irregularly-shaped polygon 66; and the open area of the opening 28 being between 5-15% of an area of the spoon 40.

The above represents example principles. Many embodiments can be made using these principles.

What is claimed is:

1. A pouch for dispensing a squeezable animal treat; the pouch comprising:
(a) a pouch body including a flexible, squeezable surrounding wall defining an interior volume; the body including an opening in communication with the interior volume;
(b) a spoon integral with and non-removably secured to the body; and
(c) the opening being non-circular with a first end adjacent to the spoon, and an opposite second end remote from the spoon;
(i) the opening having a length from the first end to the second end;
(ii) the opening having a first section of open volume from the first end to 50% of the length, and a second section of open volume from the first section to the second end; and
(iii) the first section having a greater area of open volume than the second section.

2. The pouch of claim 1, wherein the opening has a width narrower at the second end than the first end.

3. The pouch of claim 1, wherein the first section has a dimension of greatest width greater than any other width in the opening.

4. The pouch of claim 3, wherein the dimension of greatest width of the first section is 4-6 mm.

5. The pouch of claim 4, wherein the length of the opening is 6-9 mm.

6. The pouch of claim 3, wherein a ratio of the dimension of greatest width of the first section to the length of the opening is between: 0.6 and 0.8.

7. The pouch of claim 1, wherein the opening is a polygon.

8. The pouch of claim 1, wherein the opening is one of: pie-wedge shaped; tear-drop shaped; irregularly-shaped; or heart-shaped.

9. The pouch of claim 1, wherein the spoon comprises a concave bowl surrounded by a frame.

10. The pouch of claim 9, wherein the open area of the opening is at least 5% and not greater than 15% of an area of the concave bowl of the spoon.

11. The pouch of claim 9, wherein the open area of the opening is between 7-10% of an area of the concave bowl of the spoon.

12. The pouch of claim 1, wherein:
(a) the body has opposite side edges, a free end edge between the side edges, and a spoon-interface edge opposite of the free end edge and between the side edges;
(b) the body further defines a bottom panel and an opposite top panel, each being surrounded by the side edges, free end edge, and spoon-interface edge;
wherein the opening is through the top panel of the body.

13. The pouch of claim 12, wherein the first end of the opening is spaced between 1 and 15 mm from the spoon-interface edge.

14. The pouch of claim 12, wherein the first end of the opening is spaced between 3 and 10 mm from the spoon-interface edge.

15. The pouch of claim 9, wherein a ratio of a circumference of the opening to a circumference of the concave bowl is between 0.2 and 0.4.

16. The pouch of claim 1, further including a removable tab covering the opening.

17. The pouch of claim 1 wherein the interior volume is sized to hold 1-6 ounces of material.

18. The pouch of claim 1 further comprising a non-solid foodstuff suitable for animal consumption in the interior volume; the foodstuff having a viscosity of at least 80,000 cps and not more than 180,000 cps at 23°C.

19. The pouch of claim 18 wherein the non-solid foodstuff comprises any one of a puree, mash, mush, paste, liquid, sauce, broth, chowder, stew, gravy, juice, or bisque.

20. The pouch of claim 19, wherein:
(a) the bottom panel of the body also is a bottom side of the pouch; and
(b) the spoon and body comprise a same continuous material.

21. The pouch of claim 1 wherein:
(a) the body is elongated, having an aspect ratio of 2 - 6;
(b) the opening is one of: pie-wedge shaped; tear-drop shaped; irregularly-shaped; or heart-shaped;
(c) the open area of the opening is between 7-10% of an area of the concave bowl;
(d) a ratio of a circumference of the opening to a circumference of the concave bowl is between 0.2 and 0.4; and
(e) the pouch includes a non-solid foodstuff suitable for animal consumption in the interior volume; the foodstuff having a viscosity of at least 80,000 cps and not more than 180,000 cps at 23°C.

22. A method of dispensing a squeezable animal treat; the method comprising:
(a) providing a pouch body containing a non-solid foodstuff suitable for animal consumption; the body including an opening in communication with the interior volume; and a spoon integral and non-removably secured to the body;
(i) the opening being non-circular with a first half adjacent to the spoon, and an opposite second half remote from the spoon;
(ii) the first half having a greater area of open volume than the second half;
(b) putting the spoon into a dispensing configuration; and
(c) squeezing the pouch body to dispense the foodstuff from within the pouch body through the opening and onto the spoon.

23. The method of claim 22 wherein the step of putting the spoon into a dispensing configuration includes bending an interface between the pouch body and the spoon so that the spoon is angled at a non-zero angle relative to the body.

24. The method of claim 22 further including removing a tab covering the opening.

25. The method claim 22 wherein the step of providing a pouch body includes providing the pouch body having the non-solid foodstuff having a viscosity of at least 80,000 cps and not more than 180,000 cps at 23°C.

26. The method of claim 22, wherein the step of providing a pouch body includes providing the pouch body to having the opening being one of: pie-wedge shaped; tear-drop shaped; irregularly-shaped; or heart-shaped; and the open area of the opening being between 5-15% of an area of the spoon.

27. The method of claim 22 further including, before squeezing the pouch body, removing a tab covering the opening.

28. The method of claim 27, further including, after squeezing the pouch body, covering the opening with the tab.
